(19) United States
(12) Patent Application Publication
(10) Pub. No.: US 2011/0037842 A1
(43) Pub. Date: Feb. 17, 2011

(54) Cosmetic and Dermatologic Measurement Apparatus

(76) Inventors: Edward M. Hinson, Madison, AL (US); Patrick M. Kinsella, Atlanta, GA (US)

Correspondence Address: Patrick M. Kinsella, 50 Biscayne Drive-# 5108, Atlanta, GA, 30309, US

(21) Appl. No.: 12/542,006

(22) Filed: Aug. 17, 2009

(51) Int. Cl. H04N 7/18

(52) U.S. Cl. 348/77; 348/E07.085

(57) ABSTRACT

An apparatus for viewing and measuring dermatologic target areas comprising a mirror (107) having a built in display (108), a measurement scale (109), a handheld camera (202) with a hollow standoff (201) and a built in light source (303). A user input device (110) enables a subject to view images on the display (107) captured by the handheld camera (202), pressed against a target dermatologic area. The target area is measured using the measurement scale (109) and images are saved using non-volatile storage (112) for comparison.

### CROSS REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field of Invention

This invention relates to the inspection (viewing and measurement over time) of dermatologic target areas.

2. Prior Art

Cosmetic mirrors have historically included features such as built-in illumination (U.S. Pat. No. 3,714,411 to Waters, et al) and magnification options. These devices require the subject to hold up a second mirror in order to view dermatologic areas on one's back or other awkward areas. Large scale systems do exist for viewing oneself from different vantage points (U.S. Pat. No. 7,171,114 to Milton) but require significant space. In addition to devices used simply for viewing areas for grooming, measurement devices such as U.S. Pat. No. 4,905,702 to Foss have been developed for use by medical professionals to track dermatologic lesions or areas of differing pigmentation. These prior devices, however, require a third party to operate and do not allow for actual viewing by the subjects.

A more appropriate solution has been developed including a handheld imaging device which connects to a remotely located monitor (U.S. Pat. No. 5,527,261 to Monroe, et al). However, this requires many pieces of equipment, more practical for the office of a medical professional than a personal residence, and does not allow for measurement of skin lesions as there is no apparatus included for viewing areas at a fixed distance for comparison. Additionally, there is no software engine for automatically focusing or zooming using controls at the viewing monitor. Dermatologic imaging devices such as in U.S. Pat. No. 7,369,692 to Shirai, et al are intended for strong magnification and viewing of the texture of epidural layers, and can not be used for viewing of vantage points for grooming. Additionally, they do not include a software engine or display apparatus for personal dermatologic care.

Recently, video screens have been embedded in cosmetic mirrors for the viewing of promotional materials during cosmetic sales (US patent application 2002/0196333 by Gorischek) or as an added vehicular navigation feature (U.S. Pat. No. 5,940,120 to Frankhouse, et al). Again, these devices incorporate imaging into a personal cosmetic mirror, but do not allow a subject to view and measure changes in dermatologic areas or inspect oneself from varying vantage points for grooming with a small handheld device.

Accordingly, it is the principal object of this invention to provide an apparatus to view oneself from different vantage points for grooming and cosmetic purposes, while also offering a solution to view dermatologic areas and measure changes over time in a conveniently sized cosmetic appliance.

### SUMMARY

In accordance with one embodiment, an apparatus built into a cosmetic mirror including an embedded display with an embedded reticule using a hand-held imaging device to view oneself from different vantage points and view and measure dermatologic areas for comparison over time.

### DRAWINGS—FIGURES

FIG. 1 is a diagram of the display unit of one embodiment

FIG. 2 is a side view diagram of the camera unit of one embodiment

FIG. 3 is a view of the aperture (from FIG. 2) of the camera unit of one embodiment

### DRAWINGS—REFERENCE NUMERALS

101—Display unit frame

102—Left side array of light emitting diodes (LEDs)

103—Right side array of light emitting diodes (LEDs)

104—Upper mirror hinge

105—Lower mirror hinge

106—Non-volatile memory card slot

107—Mirror panel

108—LCD display

109—Reticule

110—Array of buttons

111—Cable from display unit to camera unit

112—Non-volatile memory card

201—Hollow standoff

202—Camera unit housing

203—Cable from camera unit to display unit

204—Camera unit aperture

301—Outer rim of standoff

302—Aperture of camera unit

303—Light emitting diodes (LEDs)

304—Camera lens

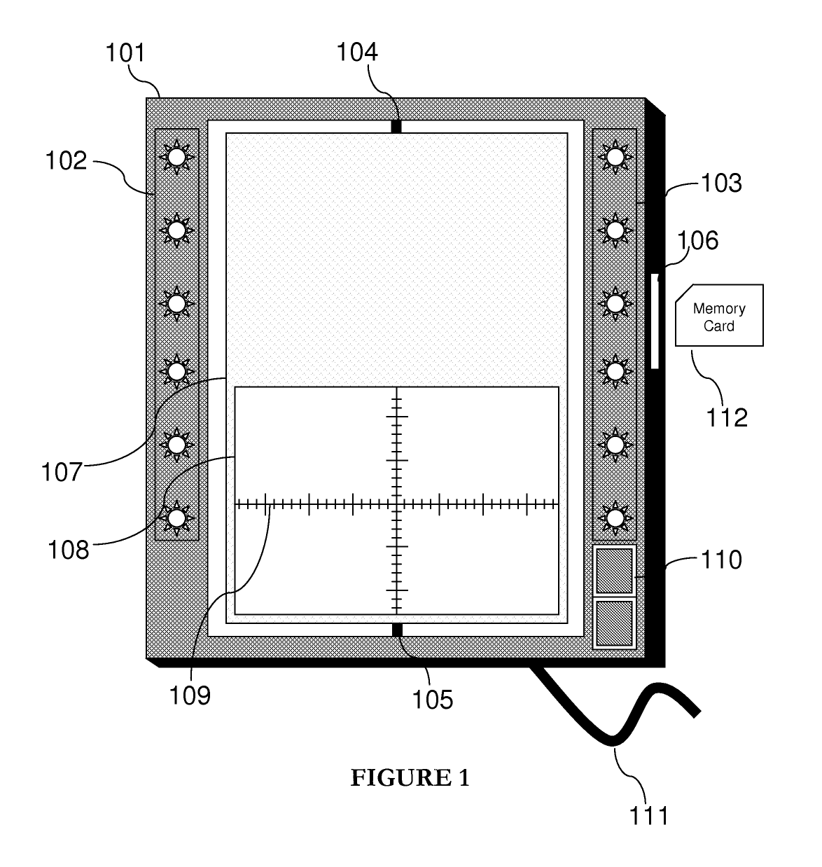

### DETAILED DESCRIPTION—FIGS. 1, 2, 3

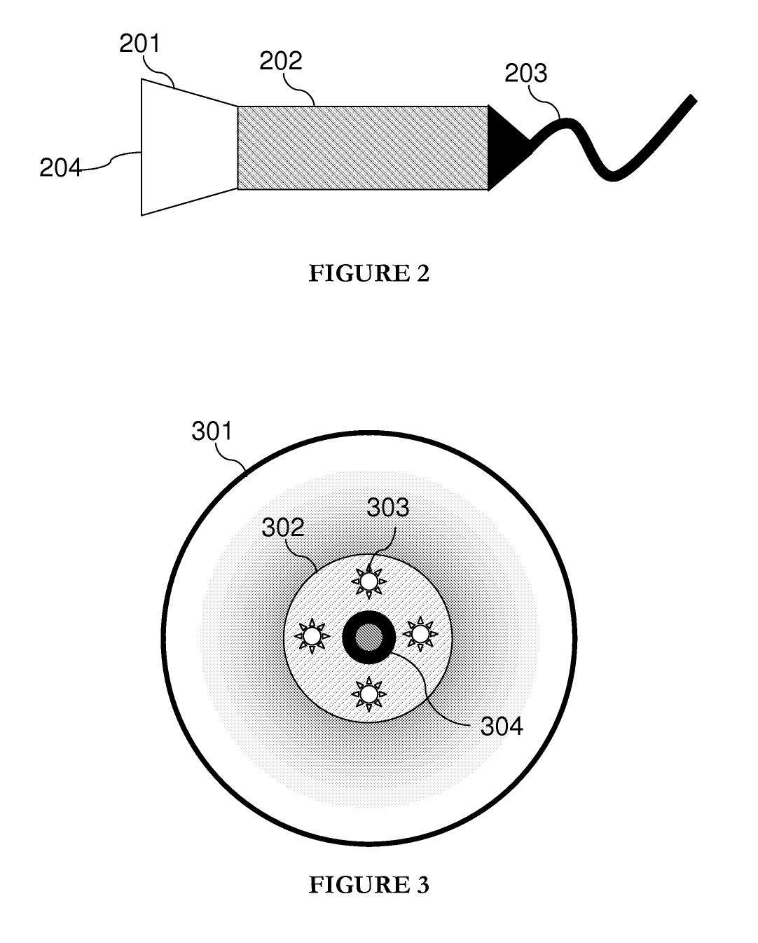

The diagram of a display unit in FIG. 1 illustrates the key components of the display unit of one embodiment and how they are connected. The display unit is housed within the display unit frame 101. On the left side of the display unit frame 101 is a left side array of light emitting diodes (LEDs) 102. On the right side of the display unit frame 101 is a right side array of light emitting diodes (LEDs) 103. A mirror panel 107 is connected to the display unit frame 101 with an upper mirror hinge 104 and a lower mirror hinge 105. Embedded under the mirror panel 107 is an LCD display 108. The embedded LCD display also contains a reticule 109. The display unit frame 101 also has an array of buttons 110 for user control and a non-volatile memory card slot 106 which can accept a non-volatile memory card 112. The display unit is connected to a camera unit in FIG. 2 via a cable from display unit to camera unit 111.

FIG. 2 illustrates the key components of the camera unit of one embodiment, primarily consisting of the camera unit housing 202. It is connected to the display unit in FIG. 1 via a cable from camera unit to display unit 203 on one end. On the other end of camera unit housing 202 is a hollow standoff 201. Inside of the hollow standoff 201 is an aperture 204.

FIG. 3 illustrates a view of the camera unit of one embodiment (from FIG. 2) facing the aperture (204 from FIG. 2). The outer border is the outer rim of the standoff 301. In the center of the standoff 301 is an aperture 302 of the camera unit. Within the aperture are light emitting diodes (LEDs) 303 and a camera lens 304.

### OPERATION—FIGS. 1, 2, 3

The display unit frame 101 retains a center mirror panel 107. The user may rotate the mirror panel 107 on upper mirror hinge 104 and lower mirror hinge 105 to a convenient angle for viewing. In the normal non-camera mode, the mirror panel 107 acts as a simple mirror. The user may illuminate the reflected object using the array of buttons 110 to turn on the left side array of LEDs 102 and the right side array of LEDs 103. The user may switch on the camera unit using the array of buttons 110. While in camera mode, LCD panel 108 is visible beneath the mirror. The user may also switch on an optional reticule 109 displayed on the LCD panel 108. The image on the LCD panel 108 is received via the cable from display unit to camera unit 111.

Once the display unit is in camera mode, the user grips the camera unit housing 202 and presses the outer rim of standoff 301 directly against the skin area wishing to be observed, exposing the area to the aperture 302 at a known distance (based on the length of the standoff 201. The LED's 303 illuminate the skin area so that the camera lens 304 can capture an image. The image is then sent to the display unit (from FIG. 1) via the cable from camera unit to display unit 203. The user may line up the specific skin area to be observed in the center of the optional reticule 109 for measurement purposes.

Images displayed on the LCD panel 108 can be time-stamped and saved to a non-volatile memory card 112 inserted into the non-volatile memory card slot 106 using the array of buttons 110.

### CONCLUSION, RAMIFICATIONS, AND SCOPE

Accordingly, the reader will see that at least one embodiment of this cosmetic and dermatologic measurement apparatus provides an improved method for subjects to view themselves from differing vantage points and measuring dermatologic areas, exceeding what is currently available by affording the following advantages:
A) Features for viewing and measurement are built into a conveniently sized cosmetic mirror for home use
B) Measuring dermatologic areas without a third party
C) Comparing stored images over time
D) Using said measurement apparatus to view bodily areas for cosmetic and grooming purposes

While my above description contains many specificities, these should not be construed as limitations on the scope of the invention, but rather as an exemplification of one embodiment thereof. Many other variations are possible. For example, the cable from display unit to camera unit 111 (same as cable from camera unit to display unit 203) could be replaced with a wireless connection. Additionally, the mirrored surface could be removed or the LCD panel 108 could be adjacent to a mirrored surface instead of embedded within it. Also, there are many different possible reticules, standoff options, and measurement scales, and the video could be stored as full motion rather than still images.

Alternative embodiments are possible to support different personal viewing applications outside of dermatologic measurement such as monitoring of alopecia or seborrhea. Thus, the scope of the embodiment should be determined by the appended claims and their legal equivalents, rather than by the examples given.

I claim:

1. An apparatus for viewing and measuring dermatologic target areas:
(a) providing a target area,
(b) providing a display,
(c) providing a measurement scale shown on said display,
(d) providing a handheld camera unit having a camera lens,
(e) providing a hollow standoff having a fixed length attached to said handheld camera unit,
(f) providing a light source adjacent to said camera lens,
(g) providing a user input device,
(h) providing a connection from said handheld camera unit to said display,
(i) providing a non-volatile storage device,
wherein said handheld camera unit is gripped and said hollow standoff is pressed against said target area illuminated by said light source wherein input is received from said user input device and said camera lens transmits imagery of said target area to said display to be measured by said measurement scale and said imagery can be saved to said non-volatile storage device.

2. The apparatus of claim 1 wherein said measurement scale shown on said display is drawn on said display by software to be enabled or disabled through said user input device.

3. The apparatus of claim 1 wherein said imagery of said target area is viewed or stored as still images.

4. The apparatus of claim 1 wherein said imagery of said target area is viewed or stored as full motion video.

5. The apparatus of claim 1 wherein said connection from said handheld camera unit to said display is wireless.

6. The apparatus of claim 1 wherein said user input device contains a universal serial bus port.

7. The apparatus of claim 1 wherein said display is embedded behind a mirror wherein said mirror becomes transparent allowing for viewing of said display when power is applied to said display.

8. The apparatus of claim 1 wherein said handheld camera unit has multiple camera lenses having different focal lengths wherein said multiple camera lenses can be selected by said user input device.
